(19) United States
(12) Patent Application Publication
(10) Pub. No.: US 2007/0073619 A1
(43) Pub. Date: Mar. 29, 2007

(54) Biometric anti-fraud plastic card

(76) Inventor: Rebecca Claudette Smith, Baltimore, MD (US)

Correspondence Address: Rebecca Claudette Smith, 15 Granny Smith Court, Baltimore, MD, 21220, US

(21) Appl. No.: 11/233,412

(22) Filed: Sep. 23, 2005

(51) Int. Cl. G06Q 40/00

(52) U.S. Cl. 705/41

(57) ABSTRACT

The biometric anti-fraud plastic card is a highly secure biometric “Smart” card that can be used for credit card purchases. Biometric technology is used to authenticate the cardholder's identity prior to use. Only for a limited amount of time after the cardholder has been authenticated does the card become active/valid and the LCD displays it's preprogrammed message. When used as a credit card the authorized user's names, account number and expiration date will be displayed on the embedded LCD. This card can be used as a direct replacement for any bare plastic smart card technology. The stored data is destroyed if the card detects any type of tampering. The “Biometric anti-fraud plastic card” makes it very difficult for unauthorized persons to make fraudulent credit card purchases.

### CROSS-REFERENCE TO RELATED APPLICATIONS

N/A

### STATEMENT REGARDING FEDERALLY SPONSORED RESEARCH OR DEVELOPMEMT

N/A

### REFERENCE TO SEQUENCE LISTING, A TABLE, OR COMPUTER PROGRAM LISTING COMPACT DISC APPENDIX

N/A

### BACKGROUND OF THE INVENTION

The present invention relates to the use of smart technology, biometrics (fingerprint) and wireless communication to authenticate users and activate the credit cards. A majority of credit card transactions are made in a store, over the Internet, at automatic-machines, or over the telephone. Each of these methods provides numerous opportunities for fraudulent or illegal transactions.

There are three types of “in-store” credit card transactions “customer signature required”, “no customer signature required” and self-check-out. For “customer signature required” transactions the customer select item(s) and brings them to a checkout cashier. The cashier scans all item(s) and states purchase amount. Cashier asks customer for payment method. Customer states credit card. Then the cashier or customer swipes credit card through reader. While the machine performs the authorization process the clerk should request photo identification from unknown customers. Assuming approval is granted, the customer signs a paper credit card receipt or special signature pad. The clerk should compare the ID's signature and photo with the customer and paper receipt signature or signature pad, rejecting credit card when discrepancies are found. “In-store” credit card transaction processes may vary slightly from store-to-store the above states just one of the many variations.

The second type of in-store credit card transaction is “no customer signature required”. This type of transaction is generally practiced at fast-food type restaurants. Customer arrives at a fast-food restaurant's drive-thru window and gives order. Cashier states purchase amount and customer drives to window presenting credit card to cashier for payment. Cashier swipes card through reader. Cashier should request photo ID for unknown customers and compare it with the customer rejecting the credit card if discrepancies exist. If approved the cashier gives the receipt to customer and the transaction is complete. While each store's credit card process may vary slight, the above explanation is only one of the many different variations.

The third type of in-store credit card transaction is “self-check-out”. “Self-check-out” is when the customer acts as a store cashier. Once the customer has completed scanning item(s) they select “finish and pay” scan bonus card and/or coupons then selects payment method. Customer selects credit and swipes credit card through reader. If approval is granted the customer is prompted to sign a special signature pad then select signature complete takes receipt and this transaction is complete. Each store implements a slightly different self-check-out process the above description is only one such variation.

For Internet credit card transactions online customers places desired item(s) in an online shopping cart once all item(s) have been selected the customer clicks checkout. Customer selects credit card as method of payment. The consumer enters his/her name, account number, billing address, expiration date and sometimes the special pin number or the 4-digit protection number imprinted on the back of the card. Once the information has been entered and verified by the customer he/she selects “complete transaction” and the seller's processes the credit card and provides a confirmation number for approved transactions. Although each web site handles credit card transactions in a slight manner the above process represents only one of the many processes.

Automatic-machines are any machines whether inside or outside a business that allows customers to purchase products or services. These types of credit card transactions involve purchasing gas (pay-at-the-pump), automatic car washes and subway or movie ticket purchasing machines. The consumer selects a service(s) or product(s) once the final selection(s) have been made the customer select complete transaction then the machine prompts the user to select payment method. For credit card he/she inserts card into the machine where it is processed and if approved a receipt is printed signifying the transaction is complete. The above is only one representation of an “automatic-machine” credit card transaction.

For telephone credit card transaction the customer calls to purchase a product(s) or service(s) such as pizza. The customer gives the order taker his/her order. The order taker asks method of payment and customer states credit card. The customer then provides to the order takes with his/her name on credit card, account number, expiration date and sometimes the special pin number or the 4-digit protection number imprinted on back of the card. Order taker enters information processes card and provides estimated time of delivery, which signifies the card, was approved and the transaction is complete. Telephone credit card transactions are not limited to pizza delivery or food industry and the above description is only one of many different types of telephone credit card transaction however, it is a good representation of the many different types of transactions.

Problems with existing credit card transactions are once the card is activated it remains that way until either the card is lost or stolen or the account canceled or closed. Credit cards are widely accepted for many different products and services. Accepting credit cards is a growing trend among merchants that were traditionally cash only businesses. Some of these merchants include fast food restaurants, movie theaters, etc. Because credit cards are being accepted in a wider market this increases the risk of fraudulent activities. Credit Cards companies such as Visa, Master Card, American Express have design and implemented anti-fraud mechanisms such as holograms, passwords, pin numbers, authorized users' signature on back and/or embedded on front of card, activation of new or replacement cards and monitoring card activities. While each method has reduced fraudulent activities no one method covers all credit card purchases and each has flaws that can easily be overcome.

With the numerous anti-fraud methods implemented by credit card companies none offers protection for each type of credit card transactions. Each of the three types of in-store credit card transactions has major flaws in their process that makes it easy for fraudulent activities. Flaws such as clerks not requesting any types of photo identifications even when “CID” pronounced” See ID” is written on the signature line or checking for signatures on back of credit cards, comparing name on credit card to name on identification or questioning any discrepancies. Some customers do not sign the back of their credit card therefore if it is lost or stolen card and the credit card company has not been notified then the card could be found signed and used by an unauthorized users. Unauthorized users who sign the back of a stolen card could produce a fake ID that matches the signature slip or special signature pad. This scenario shows that matching signatures is insufficient to authenticate the cardholder. In other words, signature matching does not guarantee the customer is an authorize user.

For “self-check-out” store clerks/employees generally monitor these checkouts for customer assistant and product thief and not request or check IDs for credit card transactions. A customer can use a credit card at a “self-check-out” without ever interacting with a store employee and would never have to produce any form of identification to be successful complete his/her transaction. These types of transactions make it easy for dishonest persons to use credit card numbers to make Internet, telephone, automatic-machine or other such purchases that do not require human interfacing to complete transactions.

Passwords and pin codes are stored on the card's magnetic stripe that can be easily read, stored on databases that can be hacked, or decoded by program algorithms. Most companies have implemented passwords and pin numbers each having different rules and requirements. Some require codes longer than 6 or less than 8, all numbers, some are case sensitive while others are not, all these rules and requirements makes it difficult for people to remember. So against the advice of the company, the user makes the password or pin number easy to remember, only change them when required, write them down everything they shouldn't. This makes is easy for a thief to obtain and use a person's pin number or password. These are just some of the reasons why passwords or pin codes provides a minimum level security. The pin code on the back of the card is not effective in preventing fraudulent purchases because a thief who has a stolen card also has the pin code. Credit card transactions, which requires passwords or pin codes are easy prey for fraud.

A customer's identity is very difficult to verify when the transaction is over the Internet. Because no human interaction for Internet transaction, anti-fraud techniques such as photo IDs, holograms and signature matching will not work. Often times the customer will be required to enter a pin number or pass code printed on back of the credit card. Algorithms can easily decode pin numbers, passwords are easy to guess/decode or hack. Using the pass code printed on the back of the card assumes that the card isn't stolen however if the card is being used by someone has stolen the card they have access the code. Thieves have been known for using cell phones to take pictures of a customer's credit card when they present it to the clerk to make purchases. With all the small portable cameras it is easy for a person to take a picture of both sides of a customers card without their knowledge. This give the thief the customer's name, credit card number, pin code (on back of card) and expiration date. A person having this information can have a duplicate card in less than 24 hours. This counterfeit card can be used for any type credit card transactions for hundreds or thousands of dollars of fraudulent purchases until it has been deactivated.

Automatic-machine credit card transactions where the customer is purchasing an item such as a car washes, movie tickets, etc. where no human interaction is required makes IDs, and signatures comparing and holograms anti-fraud techniques are ineffective. Such as holograms, ID verification, signature checking anti-fraud methods are ineffective for telephone credit card transactions. The hologram cannot be seen over the telephone and can easy to duplicated. Although the caller is required to provide credit number, expiration date and the security code printed on the back of the card the operator has no way of knowing if the customer is an authorized user.

Holograms, passwords, pin numbers, authorized users' signature on back and/or embedded on front of card, activation of new or replacement cards and monitoring card activities are the various methods implemented to prevent fraudulent activities. However, each of these methods has a flaw that still allows fraudulent transactions that results in millions of lost dollars each year. No one anti- fraud methods currently implemented protects against all methods of credit cards transaction. Once the user activates his/her new or replacement credit card it remains active making it easy to conduct transactions. There are only a few cases when a credit card is deactivated for example, the card is cancelled or reported lost or stolen, expires or the account is closed. The fact that credit cards are active most of the time provides a big window of opportunity of fraudulent activities. This window of opportunity should be as short as possible to reduce fraudulent purchases. Credit cards are being used by businesses that in the past have been cash only, which have provide numerous additional opportunities for credit card fraud. Since the market for credit cards is widens, credit card fraud will grow as well.

### BRIEF SUMMARY OF THE INVENTION

Identity theft is one of the fastest growing crimes in the United States. Each year more, than 700,000 individuals are victims of an identity thief. The yearly credit card fraud rate is between 0.05 and 0.07 percent which amounts to millions of unrecoverable dollars for financial institutions. The problems with existing credit card transactions are once the card is activated it remains that way until either the card is lost or stolen or the account canceled or closed. Store clerks don't always request or accurately verify the customer's ID information thereby allow many fraudulent activities. The biometric anti-fraud plastic card prevents fraudulent credit card activities by activating the card for a limited amount of time only after the identity of the authorizer user has been verified. The biometric anti-fraud plastic card is a plastic card that can be used for credit card transactions. It is the same size and shape as current credit cards. On the front of the card is an embedded fingerprint sensor, the “Smart Card” logo and a LCD.

Biometrics is the use of biological or behavioral characteristics such as fingerprints, retina, voice, signature, keystroke patterns etc. that uniquely identifies a person. The biometric anti-fraud plastic card requires the customer to put his/her fingerprint on the card's embedded fingerprint sensor. The fingerprint data is then used by the microprocessor to authenticate the cardholder, display authorize user's account number, name, expiration date, etc. for a pre-determined amount of time and transmit an activate card signal. Prior to all credit card transactions the cardholder must place his/her finger on the fingerprint sensor embedded on the front of the card. The authorized user's personal data (selected by the issuing institution) such as authorize user's name account number, expiration, etc. is stored on the card. After a pre-defined time has expired the card sends a deactivate signal. The deactivate signal disables the card so no credit card transactions can be successfully be processed. The LCD data is customized by the issuing and can be any alphanumeric data. The biometric anti-fraud plastic card eliminates the need to protect credit card account numbers, password, check identification and match signatures. When the LCD is on this indicates that the card is active while a blank or off display indicates the card is invalid.

The anti-fraud biometric plastic card is very difficult to counterfeit or be used by an unauthorized user. The card is standard credit card size and is compatible with all credit cards accepting machines. The biometric anti-fraud plastic card is used for making credit card purchases in-store, at automatic-machines, over the Internet and on the telephone. Additional uses include automatic teller machine, ATMs transactions and to verify a military or civilian identification.

Each authorize user will have one designated or primary finger and two backup fingerprints data scanned and retained on the card at the issuing institution. Cardholders must have their fingerprint data taken by the institution issuing the card. Instead of comparing signatures or photo ID clerks can check the display prior to scanning credit card. Regardless as to whether the clerk checks to see if the LCD is “on” the card is only valid after the authorized user has activated it for a specific amount of time.

When the anti-fraud card is not being used it will be totally useless and is equivalent to an expired credit card, no purchases can be made. Therefore, during the active time merchants must get authorization for purchases. The card will transmit an activate signal to the authorization center indicating the card is valid and the transaction is eligible to be granted authorization. The cardholder is required to activate the card by providing fingerprint data to the card's sensor prior to ALL credit card transactions.

The use of biometric fingerprint, technology to verify the cardholder's identity as the means of activating the credit card for the purpose of granting or denying credit card transactions will greatly reduce credit card fraud. The amount of time the credit card is active or valid is shorten and does not allow anyone other then the authorized user to make purchases. Even a thief who has obtained an authorized user's credit card information will not be able to use the card. Realizing criminals are using high tech devices (such as camera phones) and other techniques to steal credit card information means the way we currently use credit cards must be updated to help keep fraudulent activities low. The biometric anti-fraud plastic card updates our currently was of using credit cards by using biometrics to authenticate the cardholder as the authorized user and then activates the card for a pre-defined time period. This card provides fraud protection for all types of in-store, automatic-machine, Internet and telephone credit card transactions.

### BRIEF DESCRIPTION OF THE SEVERAL VIEWS OF THE DRAWING

This patent application contains five drawings.

FIG. 1 “Inactive Anti-Fraud Biometric Plastic Card” shows the front view of an inactive biometric anti-fraud plastic card. In this state the card in invalid and the LCD is blank.

FIG. 2 “Active Anti-Fraud Biometric Plastic Card” is a front view of an active biometric anti-fraud plastic card. This view shows an example of what type of data can be displayed on the LCD.

FIG. 3 “Data Flow Diagram” shows the flow of data for the Anti-Fraud Biometric plastic card. This view shows the how data is handled internally by the biometric anti-fraud plastic card.

FIG. 4 “Physical Block Diagram” shows the Physical flow of the Biometric Anti-Fraud plastic card. This view shows the physical components that make up the biometric anti-fraud plastic card.

### DETAILED DESCRIPTION OF THE INVENTION

The anti-fraud biometric plastic card is a highly secure “Smart” biometric self-activated card that can be used for credit card purchases. Plastic cards that use “Smart Technology” or embedded microprocessors are called “Smart Cards”. Smart cards can be contactless, contact or a combination of the two. Contactless smart cards have an antenna embedded inside the card, which allows them to communication with the reader without physical contact. Contact smart cards must communicate through make physical contact with a reader. The combination or combi card combines the features from the contractless and contact card. Smart cards have the “Smart Card” technology logo. Conventional smart card technology requires most of the software to be preloaded before the card is issued. However, new generation smart cards permit software modification after the card has been issued.

The biometric anti-fraud plastic card is a contractless smart card that can directly replace any smart technology bare plastic cards currently purchased by companies for credit cards. This card is made unique because it uses an embedded LCD combined with biometric technology in a standard credit card size plastic package. For security purposes, all software will be preloaded onto the card prior to it being issued. Authentication is the process of verifying the other party is genuine; the anti-fraud biometric card authentication is performed by the internal embedded microprocessor. This card must be customized prior to customer distribution and for security purposes the data contained on the card cannot be modified or read after the card has been issued.

Biometrics is the use of biological or behavioral characteristics such as fingerprints, retina, voice, signature, keystroke patterns etc. that uniquely identifies a person. Each person has a unique fingerprint, eye retina and voice pattern making it ideal for authenticating a person's identity. Biometric characteristics are difficult to duplicate making them ideal to use for protecting and preventing fraudulent activities. The anti-fraud biometric plastic card uses fingerprint data to authenticate the cardholder's. The issuing institution obtains and stores the authorizer(s) fingerprint data. It is the sole responsibility of the institution to verify the authorizer(s) user's identity prior to capturing and storing biometric data. The institution retains this data where it and other cardholder data, such as account number, expiration date, name, etc. will be programmed into the internal memory on the card during the manufacturing process.

Because the anti-fraud biometric card stores the cardholder's fingerprint and personal data such as name, account number, expiration data, etc. it is imperative that this information has the highest level of protection. This data will be secured so it can't be obtained and used for fraudulent activities. To ensure a high level of security it will not be possible to modify or otherwise alter the data on the card after it has been manufactured or issued. The card monitors the in the microprocessor for tampering and destroys the stored data if tampering is detected. This monitoring ensures that backward engineering is not successful. No data can be written to the anti-fraud biometric plastic card or read from the card after it has been issued. This card only transmits a signal to the authorization center, which identifies the user and tells the center the card is valid. The activate signal is a unique signal that allows the credit card company to identify each cardholder. The signal will not contain fingerprint data, full or complete account number, or names, just as an added security feature. The format for the activate signal is customer dependent and can be alphanumeric. Transmitting biometric or personal data provides an opportunity for sensitive data to be obtained and used illegally. Cards that communicate with external machines provide the opportunity for thieves to build or purchase compatible devices and read data from the card without the cardholder's knowledge. This kind of identity thief is the most dangerous since the thief can use this data for several days before the cardholder realizes he/she has been a victim. This could translate into millions of lost dollars each year for businesses.

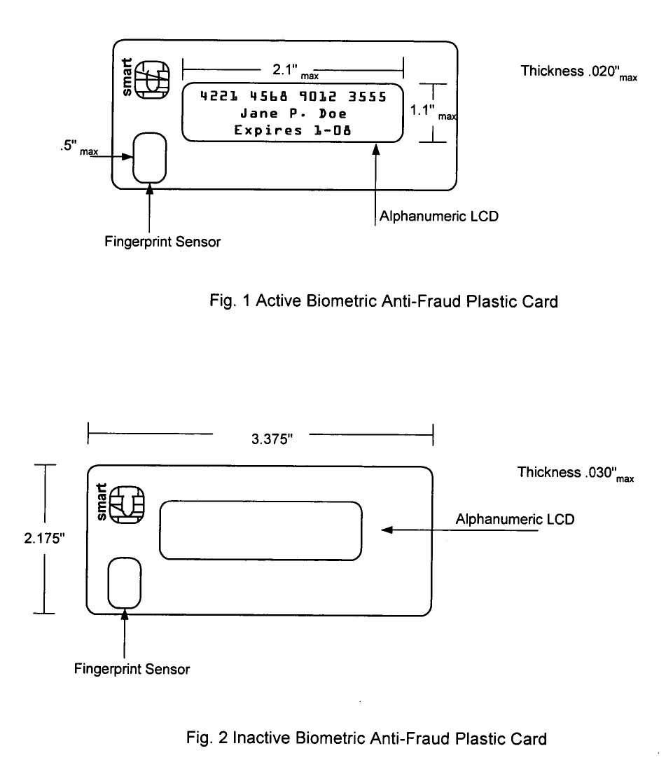

What makes this card unique? Current credit cards designs have the cardholders name, account number and expiration clearly displayed on the front of the card. This information alone is enough to make a duplicate card or make credit card purchases. In fact, thieves have been using picture cell phones to capture this information and within hours have counterfeit cards they use for fraudulent purchases. Secondly, once current credit cards are activated they remain this way until the card expires, it is lost or stolen or the account is closed. Because cards have the authorized user's name, account number, expiration date clearly displayed and the card is always activate are major flaws in the current plastic card design. The anti-fraud biometric card is unique because the cardholder's name, account number, expiration date are displayed only for a limited amount of time and card is only active for a limited amount of time as well. After the pre-defined time has expired the card is deactivated and the LCD is turned “off”, see FIG. 1 Inactive Anti-Fraud Biometric Plastic Card. When the user has been authenticated or the authorized user fingerprint has been compared and verified with the stored data the card will self-active or send out a signal to the authorization center stating the card is valid and the cardholder's name, account number, and expiration date will be made visible, see FIG. 2 Active Anti-Fraud Biometric Plastic Card. With the “Biometric anti-fraud plastic card” even if the credit card hands, it will not be possible for an unauthorized person to make a purchase.

The reasons for turning the LCD on/off are it indicates when the card is active and it gives the user access to their account information. The card can easily be design to always display this information and provide an active/inactive indicator light instead. Any unauthorized user will be denied approval for purchases. Merchants can only receive card approval when the card is active. Limiting the active state of the card and making the account name, number and expiration date available greatly reduces the window for fraudulent activities. When the card is not active it is equivalent to an expired card, no purchases can be made. Some smart cards receive power and data signals from card readers however; the biometric plastic card is self-containing and don't require external power or data signals to process and transmit data. The card has an embedded power source and clock that will be used by the card for processing and transmitting. Because the authorized user's fingerprint data activates the card and displays the credit card information, if the anti-fraud biometric card is lost or stolen it is very difficult for anyone to obtain this data. Unauthorized users will not be able to purchase items in person, over the Internet, use Automatic Teller Machines (ATM), or self-service payment machine such as gas pumps.

The anti-fraud biometric plastic card is the exact size and shape of current credit card. On the front of the card there is a LCD, an embedded fingerprint sensor and the “Smart Card” logo. The front of the card will have a fingerprint sensor to capture the user's fingerprint, which will be used for authentication. Merchants can customize this card with the same features they currently use and it is completely compatible with all current credit card accepting machines. Once an institution purchases and customize the anti-fraud biometric plastic card it can be used at all machines that accepts credit cards.

The following scenario describes the entire process that a card issuing institution will have to go through to issue a card to their customer. This scenario assumes that the card issuing institution has purchased the biometric anti-fraud plastic card and is obtaining the information from the customer for the card to be customized. Person A gets fingerprint scanned by issuing institution. The institution captures and stores the fingerprint of the authorized user(s). The fingerprint scanner used by the institution captures the fingerprint data with minimum the criteria. The fingerprint data is stored and maintained by the issuing institution on a system that have the security level no less than what they currently use to secure their customer's personal data such as account numbers, social security numbers, etc. The institution provides the data as a package in the current method used to supply the manufacturer with the embedded microprocessor data. The data package contains at a minimum the authorized user(s) fingerprint data, account number, authorized user(s) name, expiration and the active/inactive card signals that are sent to the authorization center. The active/inactive signals contain enough information for the card center to differentiate one cardholder from another. The issuing institution provides this data to plastic card manufacturer using the same medium currently used to transmit data stored on their plastic cards. The manufacturer programs the microprocessor with the package data using the same method they currently use to program their smart card processors.

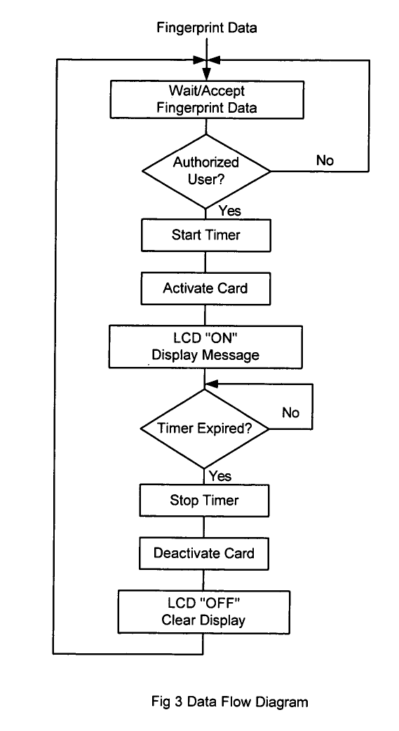

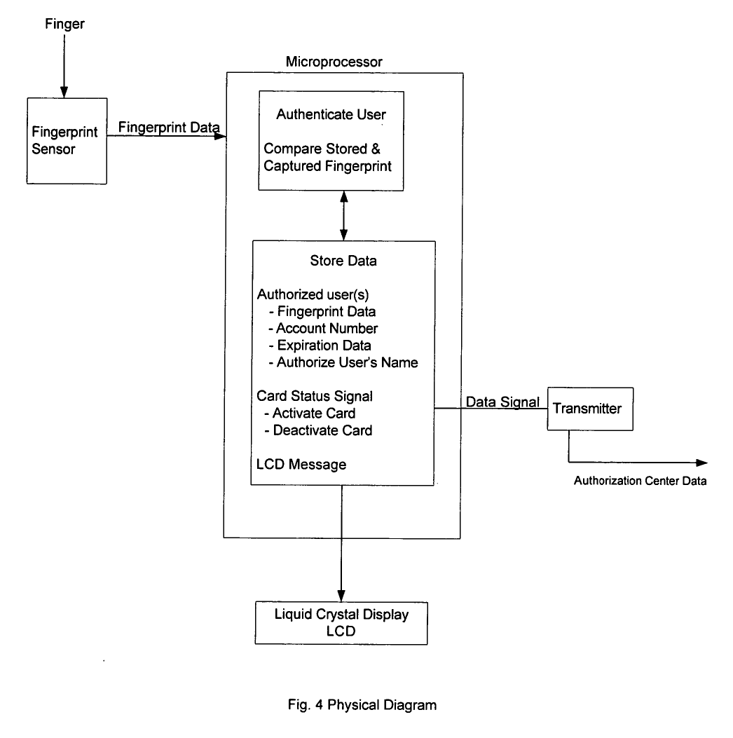

The microprocessor stores all the data provided by the issuing institution. This information is used during the credit card transaction process. The flow of data when a user's places his/her finger on the fingerprint sensor is shown FIG. 3 Data Flow Diagram. The Biometric Anti-fraud plastic card performs four functions, captures data, processes data, displays data and transmits data. Data is captured by the fingerprint sensor, which is sent to the microprocessor for authenticating. Once the microprocessor receives the data it compares it to the stored authorized user(s) fingerprint data. If there is a match then the microprocessor takes the active card signal and sends it via embedded transmitter to the authorization center. This signal lets the center know that the authorized user wants to make a purchase and pending further processing (such as the limit is not exceeded) authorization can be granted to this card. Concurrent with this action the microprocessor sends the “on” command to the LCD and displays the authorized user name, account number expiration date, etc. The microprocessor starts the inactive card timer (time defined by issuing institution) once the time has expired the microprocessor will send the inactive card signal to the authorization center and “off” command to the LCD.

The manufacturer contacts the LCD and fingerprint sensor to the embedded smart microprocessor using standard embedded process. FIG. 3 shows the Physical Block Diagram components that perform the main functions of the biometric anti-fraud plastic card. The LCD is centrally located from the top, bottom and left and right sides of the standard credit card size plastic package. The LCD is 2.1 inches max in length, and 1.1 inches max. height and a maximum thickness of 0.020”. The fingerprint sensor in the bottom left side of the plastic card. Its left edge is at least a half-inch from the left edge of the card.

The biometric anti-fraud credit card can be used for in-store, over the Internet, automatic-machines (such as ATMs, pay-at the pump, etc.), or over the telephone. The following scenarios describe how the anti-fraud biometric plastic credit card is used for authorized and unauthorized persons.

There are three types of in-store credit card transactions “customer signature required”, “no customer signature required” and “self-check-out”. For “customer signature required” transactions the customer select item(s) and brings them to a checkout cashier. The cashier scans item(s) states purchase amount to customer and the customer states credit card as payment method. The customer/authorized user places designated finger on the card's fingerprint sensor. After the card has verified the cardholder is the authorize user the LCD shows the customer's name, account number and expiration date while at the same time the card sends out the activate signal to the authorization center. Then the customer or cashier swipes credit card through reader. Assuming the customer meets all other credit card factors (such as within credit limit, etc.) the final approval is sent to the store by the authorization center. After the predefined time period has expired the LCD is cleared and the card sends a deactivate signal to the processing center. The stores still have the option to require the customer to sign a paper credit card receipt or special signature pad but it is not necessary. Since the cardholder's identification has been verified through the use of biometric this step is completely optional.

The second type of in-store credit card transaction is “no customer signature required” this type of transaction is generally practiced at fast-food type restaurants. Customer arrives at a fast-food restaurant's drive-thru window states food order cashier states purchase amount. Customer drives to window presents credit card for payment to cashier but forgets to activate the card. The cashier takes credit card and swipes it without checking the LCD. The credit card machine tries to get authorization but since the card is not activated the sale is rejected. The cashier tells the customer the card was rejected and the customer realizes that he/she forgot to activate the card. The cashier returns the card back to the customer who then places his/her designate finger on the sensor activating the card and displaying the appropriate information. The customer apologizes give the card back to the cashier. When the card is re-swiped the sale is approved and the transaction is completed. After the predefined time period has expired the LCD is cleared and the card sends a deactivate signal to the processing center.

The third type of in-store credit card transaction is “self-check-out”. For a self-check-out the customer acts as a store cashier. A customer who has stolen a biometric anti-fraud credit card decides to try to make an in-store purchase at a self-check out register. This customer is feeling real confident since no store clerk will request identification. The customer has completed scanning all item(s) then selects finish and pay; scans bonus card and/or coupons. Selects credit as payment method when prompted by checkout register. Since the customer is trying to use a stolen card he/she is unable to activate the card but swipes it anyway. Thinking he/she is safe because no cashier will notice that the LCD is blank the customer swipes credit card through reader. The sale is rejected because the card is not activated. The customer then places his/her finger on the sensor but the LCD is still blank, the customer swipes the card several times each time getting denied. A store employee notices the customer is having problems and comes to assist the customer. Knowing the card is stolen he/she runs out the store without making a purchase.

Each merchant handles in-store credit card transaction slightly different the above scenarios are just one way and do not affect how the card is used. Regardless to the credit card process, the card must be activated prior to the merchant processing the credit card. It is not necessary for merchants to verify the card is active by looking at the LCD, if the card is not active the transaction will not be approved.

For Internet credit card transactions the authorized user/customer select item(s) placing them into an online shopping cart once all item(s) have been selected the customer clicks checkout. Customer selects credit card as method of payment. Before selecting process payment the customer places his/her designate finger on the sensor activating the card and displaying the appropriate information. The consumer enters his/her name, account number, billing address and expiration date onto the Internet form and then selects process payment. Because the card is active the sale is approved. After the predefined time period has expired the LCD is cleared and the card sends a deactivate signal to the processing center. Although web sites may handle credit card transactions in a slight manner the above process explains only one of the many processes. Regardless to the credit card process, the card must be activated prior to the merchant processing the credit card.

Automatic-machines are any machines whether inside or outside a business that allows customers to purchase products or services. These types of credit card transactions involve purchasing gas (pay-at-the-pump), automatic car washes and subway or movie ticket purchasing machines. The consumer/authorized user selects a service(s) or product(s) once the final selection(s) have been made the customer select complete transaction. The customer selects credit as payment method prompted by the machine. Before inserting the card the customer places his/her designate finger on the sensor activating the card and the LCD displays the appropriate information. Customer inserts active card into machine. The approval is received and a receipt is printed. After the predefined time period has expired the LCD is cleared and the card sends a deactivate signal to the processing center. The above scenario is just one way in which automatic-machine credit card purchases are made, however this does not affect how the biometric anti-fraud card works. The card must be active prior to merchant processing the credit otherwise the transaction will be denied.

A pickpocket sees the customer from the above scenario make an ATM withdrawal. Without the persons knowledge he/she steals the card. The pickpocket decides to make a telephone credit card purchase before the customer has time to report it stolen. Because the card was active when it was stolen the pickpocket decides to write down the information on the LCD. He/she takes the card and uses his/her cell phone to purchase a laptop over the phone. While placing the order the card deactivates. When it is time for the pickpocket to give the credit card information he/she give the information that was written down from the LCD since the display is now blank. The phone clerk tries to process the card but each time it is reject. Not knowing that the card was stolen the phone clerk tells the pickpocket the card was rejected and the pickpocket hangs up the phone and throws down the card. Each Internet merchant processes credit card transactions differently, however this does not affect the biometric anti-fraud plastic card since it must be active prior to the merchant processing the card.

Financial institutions, retail stores and various types of merchants purchase and customize (add company logo, visa/master card symbol, smart card icon, etc.) bare credit card plastic prior to issuing to their customers. The biometric anti-fraud plastic card is an improvement to all types (smart card, traditional, etc.) of the current bare plastic used for credit cards and follows the same manufacturing processes. This card can be used in all machines that currently accept credit cards such as Visa, MasterCard, etc. Merchants that offer credit cards purchase can purchase the biometric anti-fraud plastic cards and have it customized prior to issuing to their customers.

The improvements to current bare smart technology plastic cards are the card has a fingerprint sensor, LCD embedded on the front of the card, the ability to communicate to credit card authorization centers, limited active time and the ability to deactivate credit card. These improvements make the biometric anti-fraud plastic card the most advance and secure plastic card available.

What I claim as my invention is:

1. An embedded fingerprint sensor on the front of a credit card size plastic card that is used to authenticate the cardholder prior to use.

2. An embedded LCD on the front of a plastic card that will display preprogrammed data such as cardholder's name, credit card number and expiration date.

3. A plastic card self-activated by an authorized user and valid (active) for a limited amount of time.
